(19) United States
(12) Patent Application Publication
(10) Pub. No.: US 2024/0362608 A1
(43) Pub. Date: Oct. 31, 2024

(54) Payment method, system and computer software product

(71) Applicant: FocalPay AB, Stockholm (SE)

(72) Inventors: Morteza KALHOUR, Vällingby (SE); Birkir VEIGARSSON, HÄGERSTEN (SE)

(21) Appl. No.: 18/766,709

(22) Filed: Jul. 9, 2024

Related U.S. Application Data
(63) Continuation of application No. PCT/SE2023/050024, filed on Jan. 10, 2023.

(30) Foreign Application Priority Data
Jan. 11, 2022 (SE) 2250013-6

(51) Int. Cl. G06Q 20/22; G06Q 20/20

(52) U.S. Cl. CPC G06Q 20/227; G06Q 20/20

(57) ABSTRACT

A method for performing a transaction between a second client and a first client, comprising: defining a transaction, including a payment amount; the first client sending the transaction to a central server; the defined transaction being associated with an identifier; the second client providing, to the central server and using said identifier, payment information comprising a desired payment channel; said payment being executed based on said payment information, using said desired payment channel and the central server being provided payment confirmation information; and the central server providing, to the first client and using said identifier, payment confirmation. The invention also relates to a system and to a computer software product.

The present invention relates to a payment method. It also relates to a payment system arranged to perform such a method, and to a computer software product arranged to perform such a method. The computer software product may constitute a part of said system.

Today, a proliferation of payment technology solutions exists. Apart from physical bills and coins, these include, for instance, paying using physical or virtual/tokenised credit or debit cards; direct digital bank account transfer payments; online payment services; and crypto currency payments.

When a customer wants to pay for goods or services at a physical or virtual POS (Point Of Sale), the POS will typically present the customer with a list of available payment methods. The customer then selects one of these, and pays for the goods and services using the payment in question. For instance, the payment may be effectuated using a particular selected credit card or using an online payment service such as Paypal® or Swish®.

If the POS offers many different possible payment methods, this may complicate things for the customer. For instance, personnel at the POS may have to read all the available options to the customer out loud, or the customer may have to scroll through a list of all available options. Since the customer probably only prefers using one or possibly a few different payment methods, this is inefficient. In case the customer has a preferred method of paying, when asking at the POS if the POS accepts this preferred method of payment the answer may turn out to be in the negative. This is inefficient.

The procedure is also burdensome for the POS, that needs to support a user interface allowing personnel to select a desired method of payment or, in the case of an unmanned POS, allowing the user to perform the selection.

Many different solutions have been proposed to simplify the payment process at a POS. However, many of these solutions require the user to take certain actions ahead of time, such as installing a local application on her smartphone, to sign up for a particular service, and so forth. Once at the POS, it is then not guaranteed that the POS in question accepts such payments at all, or that the payment service in question is currently active or enabled.

Furthermore, there is a general problem keeping track of payments in relation to specific purchases. For instance, in the conventional setup the customer pays for a purchased good and receives a receipt. If the receipt is lost, it is difficult for the customer to prove that payment had actually been made. Among other things, the conventional return (repurchase) process is typically complicated and burdensome for the customer.

The present invention solves at least some of the above described problems, in that it provides a way of paying for goods or services that offers both the customer and the POS more flexibility and simplicity, while maintaining full transaction security and certainty.

Hence, the invention relates to a method for performing a transaction between a second client and a first client, the method comprising a transaction definition step, wherein a transaction is defined, the defined transaction comprising transaction information in turn comprising a payment amount; a transaction sending step, wherein the first client sends the defined transaction to a central server, or wherein the first client sends the defined transaction to the second client that in turn sends the defined transaction to the central server together with information identifying the first client; an association step, wherein the defined transaction is associated with an identifier; a payment information provision step, wherein the second client provides, to the central server and using said identifier, payment information, the payment information comprising a desired payment channel; a payment execution step, wherein said payment is executed based on said payment information, using said desired payment channel and the central server is provided payment confirmation information regarding said payment; and a payment confirmation step, wherein the central server provides, to the first client and using said identifier, payment confirmation.

Furthermore, the invention relates to a system for performing a transaction between a second client and a first client, the system comprising a central server arranged to perform a transaction sending step, wherein a defined transaction is received from the first client, or wherein the defined transaction is received from the second client in addition to information identifying the first client, the defined transaction comprising transaction information in turn comprising a payment amount; an association step, wherein the defined transaction is associated with an identifier; a payment information provision step, wherein payment information is received from the second client using said identifier, the payment information comprising a desired payment channel; a payment execution step, wherein said payment is executed based on said payment information, using said desired payment channel, and wherein payment confirmation information is received regarding said payment; and a payment confirmation step, wherein the payment confirmation is provided to the first client using said identifier.

Moreover, the invention relates to a computer software product for performing a transaction between a second client and a first client, the computer software product, when executed on or from a central server, the first client and/or the second client, being arranged to perform a transaction definition step, wherein a transaction is defined, the defined transaction comprising transaction information in turn comprising a payment amount; a transaction sending step, wherein the first client sends the defined transaction to a central server, or the first client sends the defined transaction to the second client that in turn sends the defined transaction to the central server together with information identifying the first client; an association step, wherein the defined transaction is associated with an identifier; a payment information provision step, wherein the second client provides, to the central server and using said identifier, payment information, the payment information comprising a desired payment channel; a payment execution step, wherein said payment is executed based on said payment information, using said desired payment channel and the central server is provided payment confirmation information regarding said payment; and a payment confirmation step, wherein the central server provides, to the first client and using said identifier, payment confirmation.

In the following, the invention will be described in detail, with reference to exemplifying embodiments of the invention and to the enclosed drawings, wherein:

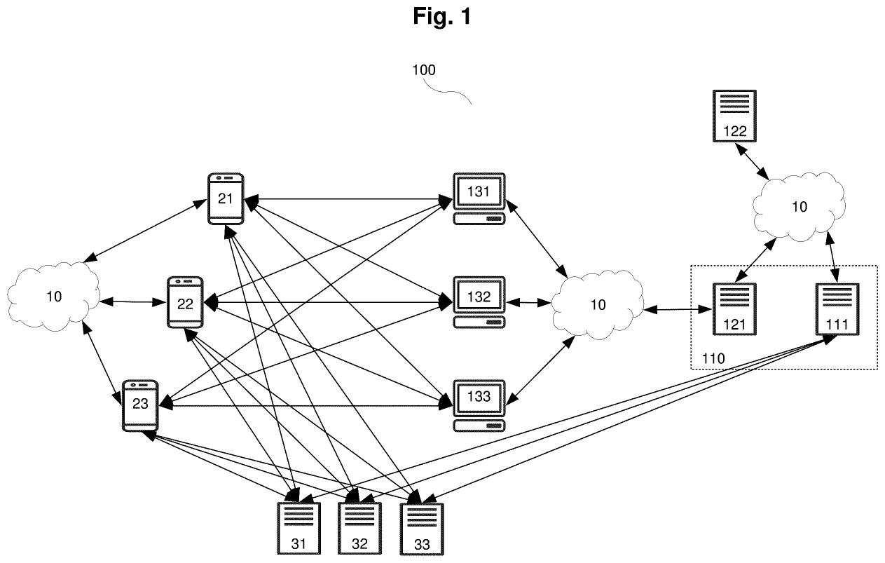

FIG. 1 is an overview of a system according to the invention;

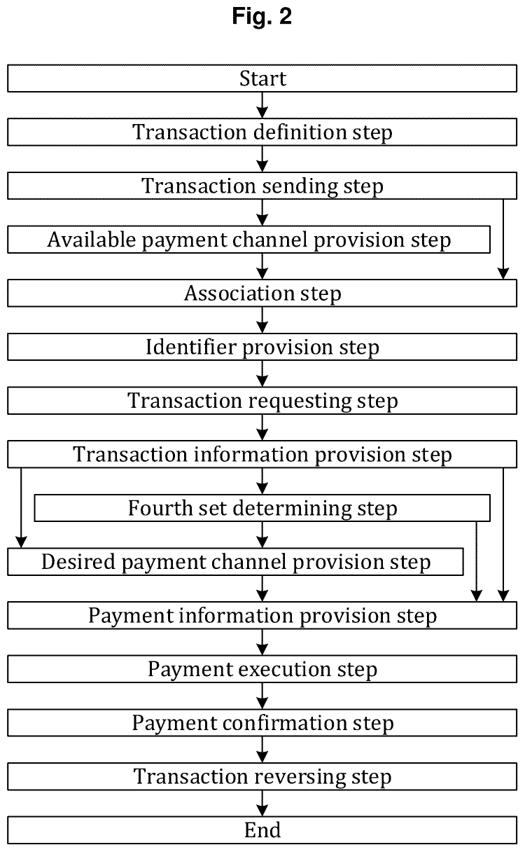

FIG. 2 is a flowchart showing possible steps in a method according to the present invention;

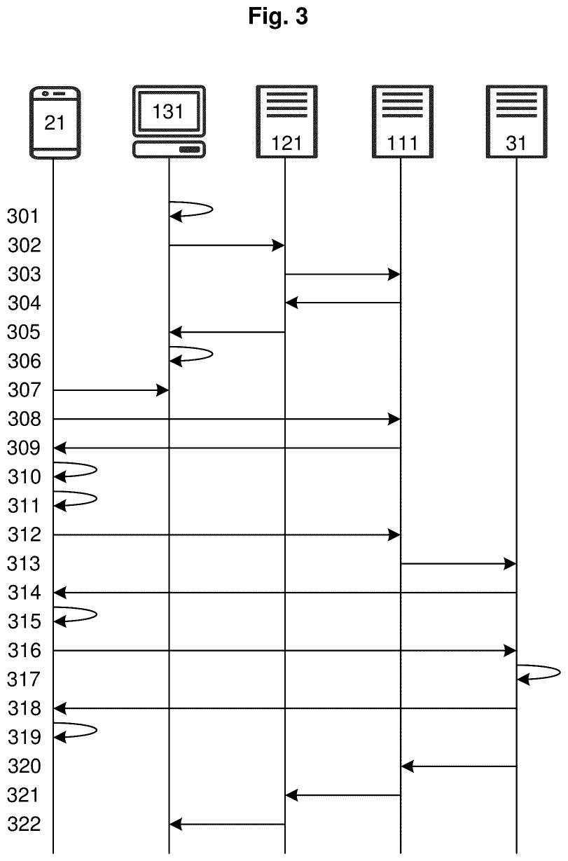

FIG. 3 illustrates a first example of an information flow when performing a method according to the present invention; and

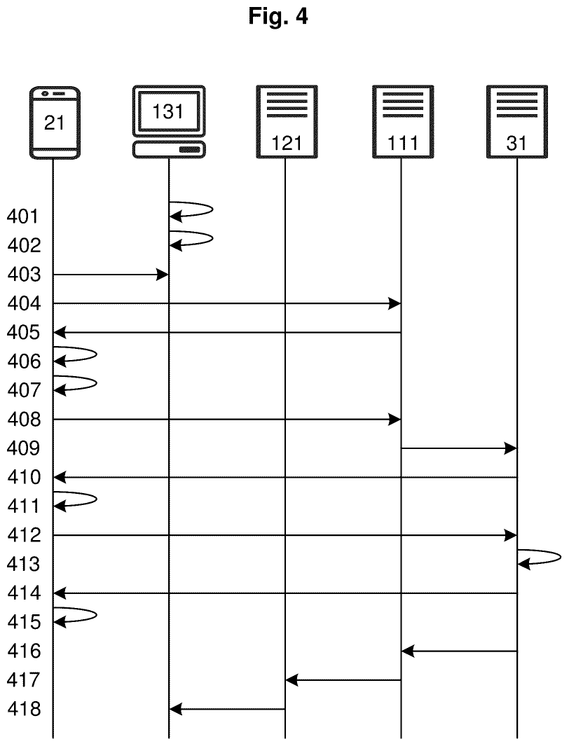

FIG. 4 illustrates a second example of an information flow when performing a method according to the present invention.

FIG. 1 illustrates a system 100 according to the invention, the system 100 being arranged to perform a method according to the present invention.

In particular, a central server 111 is arranged to perform many of the functions and much of the functionality required to perform said method, and as will be described and exemplified in detail below.

As used herein, the term “central server” denotes a centralised functionality in the sense that the functionality is accessed in a logically central location. For instance, the central server in question may expose an API (Application Programming Interface) that can be reached via the internet 10 in a consistent manner from other various clients, the central server providing said functionality via said API. The functionality in question may be implemented in software and/or hardware on one or several disjoint physical or virtual pieces of computer hardware, where examples include a standalone server locally executing purpose-built software; a corresponding virtual server running on a physical server infrastructure; and a set of interconnected physical or virtual server computers collaborating to offer said functionality using purpose-build software as a distributed piece of software executing from said several servers in parallel. Such functionality may furthermore generally be replicated across several central servers operating in parallel, such servers dividing an available amount of computing work among them based on some predetermined principle, for instance based on geography, task, a round-robin scheme and so forth.

At least one, preferably at least two, POS servers 121, 122, that may also be “central servers” in said sense, is in digital communication with the central server 111, such as via the internet 10. At least one such POS server 121, 122 may be located at each POS (Point Of Sale). Such a POS may be a physical point of sale, for instance a physical store or cashier, or a virtual point of sale, such as an online store accessed via a web page or an application locally installed in, or at least accessed from an application locally installed on, a client device (an “app”). Herein, “locally installed” refers to a computer software product that is installed on top of an operating system of the device in question and can execute within that operating system environment. In some examples, each physical and/or virtual POS in a chain of such POS is arranged with a respective POS server 121, 122, serving the POS of said chain. All POS servers 121, 122 may communicate with one and the same central server 111 or array of such central servers 111.

As is illustrated in FIG. 1, the central server 111 and a POS server 121 may be viewed as one single central server 110, depending on the configuration of the system 100.

At least one, preferably at least two, merchant computers 131, 132, 133, that may also be “central servers” in said sense, expose a respective interactive UI (User Interface), such as an interactive GUI (Graphical User Interface) to at least one of a first transaction party or client and a second transaction party or client. In examples provided herein, the first client is a merchant, selling some good or service; whereas the second client is a customer buying said good or service. In methods according to the invention, the second client therefore conducts a payment to the first client, such as a payment for such a purchased good or service.

The GUI can be presented on a physical screen of the merchant computer 131, 132, 133 in question and/or on a physical screen of a client device 21, 22, 23 (see below). For instance, a physical screen on the merchant device 131, 132, 133 may be a checkout station or cashier in a physical store, the GUI providing checkout and payment functionality in said store. In other examples, the GUI may be viewed in a browser on the client device 21, 22, 23 in connection to, being, or forming part of, a web page provided by a merchant as an online in store. In yet additional examples, two clients may operate one respective client device 21, 22, 23 each, said GUI being presented on a respective screen of one or both of said client devices 21, 22, 23 and providing functionality for sending money from the second client to the first client. In the latter case, one of the clients 21, 22, 23 plays the part described below for the client 131, 132, 133.

Each of said client devices 21, 22, 23 may be a smartwatch, a smartphone, a PDA, a laptop computer or any other electronic device having user input means (such as a screen capable of presenting a GUI and/or physical buttons) for allowing a user of the client device 21, 22, 23 in question to input data necessary to conduct a transaction as described below.

In some embodiments, at least one, such as each, of said client devices 21, 22, 23 comprises a sensor arranged to provide a local, digital reading of a parameter in order to collect information identifying a particular transaction. Such a sensor may be a digital camera being able to read a visual marker, such as a QR code; a microphone arranged to record a sound coding for said information; a motion sensor (for instance a MEMS component), arranged to detect a gesture performed by a user of the client device 21, 22, 23 in question; or an interactive GUI.

In some embodiments, the merchant 131, 132, 133 GUI may comprise functionality allowing a merchant personnel and/or a purchasing customer to select or register products or services to purchase; and/or to define a transaction to be conducted (such as a money transfer). Such selection functionality may in itself be similar to functionality offered by conventional POS cashier systems, that may be equipped with an RFID reader to scan articles to be purchased; self check-out stations in physical stores; online web stores; and so forth.

In some embodiments, a particular second client (purchasing party) GUI, provided on the client device 21, 22, 23, may provide functionality for selecting a desired payment channel and/or to interactively conduct method steps necessary to perform and finalise a payment using such a payment channel.

As is understood from the above, the functionality of the respective GUIs may vary. What is important is that the combined functionality of the various devices 21, 22, 23, 131, 132, 133 supports the below-described method. In particular, and as will be understood from the below, such functionality builds upon each merchant computer 131, 132, 133 and each client device 21, 22, 23 interacting with the central server 110, 111 and/or 121 to perform the various method steps, and that a direct interaction between a client device 21, 22, 23 and a merchant computer 131, 132, 133 is restricted, such as restricted to exchanging identifying information about a particular transaction (for instance a transaction identifier), which identifying information is then in turn merely used to identify a particular current transaction in communication with the central server 110, 111, 121. This will be described below. As will also become clear in the following, a client device 21, 22, 23 can in some embodiments also relay transaction information from another client device, such as from a merchant computer 131, 132, 133, to the central server 110, 111, 121.

Each one of said devices 111, 121, 122, 131, 132, 133, 21, 22, 23 may comprise standard, general-purpose computer hardware, such as a CPU, a GPU, a data bus, RAM and ROM memory and conventional IO hardware; or comprise corresponding virtualisation software in turn executing on such physical hardware. Communications between devices may be using standard wired or wireless internet 10, as the case may be.

The system 100 may encompass at least the central server(s) 110, 111, 121, 122. In some embodiments, the system 100 further encompasses the merchant computers 131, 132, 133, or at least a piece of computer software code or a computer software product executed on or from the merchant computers 131, 132, 133, specifically adapted so as to perform the functionality provided by the same. In yet additional embodiments, the system 100 also encompasses a piece of computer software code or a computer software produce executed on or from the client devices 21, 22, 23 specifically adapted so as to perform the functionality provided by the same.

In addition thereto, the system 100 will typically and in particular comprise any computer software code or product executing on or from any of said central servers 110, 111, 121, 122 specifically adapted so as to perform the functionality provided by the same.

FIG. 1 also illustrates three different payment services 31, 32, 33. Such payment services are normally not part of the system 100, but are provided by third part payment service operators. Examples of such third party payment services include Swish®, Vips®, PayPal®, VISA® and MasterCard®. As is illustrated in FIG. 1, such payment services generally offer API communication capabilities, and the client devices 21, 22, 23 as well as the central server 111 are arranged to communicating with said payment services 31, 32, 33 via their respective APIs in the ways described below.

In some cases, the central server 111 may itself implement and provide a payment service provider. In other cases, the payment service provider 31, 32, 33 is provided by an external party.

FIG. 2 illustrates a method according to the present invention, for making a payment from a second client to a first client. Unless otherwise stated, all method steps are performed automatically by respective specifically adapted software functions executing on or from the relevant entities in question. All communications and information processing is typically digital and electronic.

In a first step, the method starts.

In a subsequent transaction definition step, a transaction is defined. The “transaction” may be a purchase of a good or service, where the second client 21 (or a user of the second client) is a buying/paying party and the first client 131 (or a user of the first client) is a selling/payee party. In other embodiments, the “transaction” may be the transfer of a value, such as of a money amount, of a cryptocurrency amount or a transfer of some other asset. To “define” the transaction means to determine information sufficient to characterise the transaction from the points of view of said two parties. Respective identities of a payer and/or a payee may or may not be part of the “transaction” at this point.

In all such transactions, however, there will be a payment amount. Such a “payment amount” is a metric of an amount of the value transferred with or without an associated transfer of a good or service. Or instance, the payment amount may be a purchasing price, in a currency, for a purchased good or service.

Hence in the transaction definition step, the defined transaction comprises transaction information in turn comprising a payment amount. In this context, the “transaction information” may be information sufficient to define the transaction, for instance sufficient to uniquely define and/or identify the transaction. This “transaction information” may comprise various information in addition to said payment amount, such as information regarding a purchased good or service; various transaction conditions; an identity of the first 131 and/or second client 21 and/or corresponding user; a time stamp; the first client's 131 transaction identifier, and so forth.

The transaction definition step may be performed by the first client 131, such as when a cashier clerk scans items to be purchased at a physical POS or when a buying customer performs a self-checkout at a physical store. The transaction definition step may also be performed by the second client 21, such as when a buying customer has added one or several items to a virtual shopping cart and proceeds to checkout in an online web store operated via a browser running on the second client 21. The transaction definition step can also be performed collaboratively by the first client 131 together with some additional client, such as together with the second client 21, for instance in case a buying customer uses the second client 21 to select items to purchase in a physical POS based on information locally communicated at said physical POS from the first client 131. In some embodiments, the transaction may be defined as a transaction of a predetermined type of transactions, such as relating to a predetermined good or service and/or being associated with a predetermined price or other payment amount. What is important is that the transaction is defined in a way so that the first client 131 gains sufficient knowledge about the transaction in order for the first client 131 to determine the payment amount and to what the payment amount relates. Hence, in case the first client 131 is not the sole entity used to perform the transaction definition step, the transaction information is provided to the first client 131.

In a subsequent transaction sending step, the first client 131 sends the defined transaction to the central server 110, 111, 121. In this case, “the defined transaction” may be the same as, comprise, or at least comprise a subpart of, the above-discussed transaction information. What is important is that the defined transaction sent by the first client 131 in this transaction sending step is sufficient for the second client 21 to, together with any information already in the possession of the second client 21, discern what the defined transaction relates to. Normally, the payment amount will be a part of the defined transaction sent in the transaction sending step.

In alternative embodiments, the transaction sending step comprises the first client 131 sending the defined transaction (with the same meaning as above) to the second client 21, that in turn sends the defined transaction to the central server 110, 111, 121 together with information identifying the first client 131. For instance, in the case of a physical POS the physical POS may provide the defined transaction (comprising for instance an amount to be paid) to the second client 21, and the second client 21 may send this information to the central server 110, 111, 121 via a suitable API of the central server 110, 111, 121. In the latter communication, information identifying the physical POS will then be sent together with the defined transaction from the second client 21 to the central server 110, 111, 121. This identifying information may then be any piece of information allowing the central server 110, 111, 121 to identify the first client 131 with the purpose of identifying a payee to the transaction in question.

In a subsequent association step, performed by the central server 110, 111, 121 (or possibly the first client 131), the defined transaction is associated with a transaction identifier. The transaction identifier may be any code or alphanumeric sequence identifying the defined transaction sufficiently uniquely so as to be able to discern the individual defined transaction from other transactions within the system 100. For instance, the transaction identifier may be a system-globally unique identifier.

In a subsequent identifier provision step, that may be performed before the below-described transaction information provision step, said transaction identifier may be communicated to the second client 21.

This communication is then performed by the second client 21 reading said transaction identifier by performing at least one of the following communication actions. In the above-described alternative embodiment in which the defined transaction is sent to the central server 110, 111, 121 from the first client 131 via the second client 21, the transmission of the defined transaction from the first client 131 to the second client 21 (for relaying further to the central server 110, 111, 121) may take place in a way corresponding to the following alternative actions. Furthermore in such alternative embodiments, the transaction identifier may then be provided from the central server 110, 111, 121 directly to the second client 21 instead of being provided from the first client 131 to the second client 21.

In a first alternative communication action, a displayed visual code is visually depicted, using said digital camera of the second client 21, the visual code signifying the transaction identifier (or defined transaction). The visual code may be a QR code, a barcode, a printed or otherwise displayed alphanumeric code, a predetermined shape, and so forth, where the important aspect is that the visual code signifies, to a reader depicting the visual code in said way and interpreting the visual code, sufficient information to uniquely be able to identify the defined transaction. For instance, the visual code may be, comprise or in any other way unambiguously signify the transaction identifier. For instance, the transaction identifier may be calculable in an unambiguous manner based on a piece of information readable from the visual code. The depicted digital image information may be interpreted using standard digital image processing methods, such as optical character recognition or standard QR code analysis, to evaluate and interpret the visual code in order to extract, calculate or otherwise determine the transaction identifier.

In a second alternative communication action, an emitted audio code is recorded using a microphone of the second client 21. The audio code may be similar to said visual code, in the sense that it is formed to code a piece of information readable from the audio code and that may be used by the second client 21 to unambiguously determine the transaction identifier (or defined transaction). For instance, the audio code may be modulated onto a carrier sound wave in a way which is conventional as such. The recorded digital sound information may then be interpreted using standard digital sound processing methods, such as using a digitally implemented fast Fourier transform-based analysis, to evaluate and interpret the audio code in order to extract, calculate or otherwise determine the transaction identifier.

In a third alternative communication action, a wireless signal is received, using an antenna of the second client 21, the wireless signal signifying the transaction identifier (or defined transaction). In a way corresponding to what has been said about the visual code and the audio code, the wireless signal may be used by the second client 21 to unambiguously determine the transaction identifier, by a piece of information allowing this to be conveyed over a wireless signal received by said antenna. For instance, a per se conventional wireless technology such as active RFID, Bluetooth®, ZigBee, NFC or wifi may be used to send the piece of information as a digitally coded piece of information to the second client 21. The received signal may then be evaluated and interpreted in order to extract, calculate or otherwise determine the transaction identifier.

It is noted that the first, second and third alternative communication actions presupposes physical proximity between the first client 131 and the second client 21, and that the transaction identifier (or defined transaction, as the case may be) is read by the second client 21 from the first client 131. In other words, the transaction identifier may be locally communicated to the second client by the first client. In other embodiments, however, the transaction identifier may be provided to the second client 21 using a GUI provided on the second client 21 itself, such as in the above-discussed example when a web shop is accessed via a browser running on the second client 21.

Hence, in a fourth alternative communication action a user of the second client 21 is allowed to select a graphical object, link or URL in a user interface presented on a screen of the second client 21; or the user is allowed to enter a piece of information, such as using a text input means of said user interface, signifying the transaction identifier (or defined transaction). In practical examples, said user may select a product or service to purchase in an interactive GUI presented in a browser of said type on the screen of the second client 21.

Before the identifier provision step, the transaction identifier may be communicated from the central server 110, 111, 121 to the first client 131. In alternative embodiments, the first client 131 is the entity determining the transaction identity in the above-described association step, and then communicates the transaction identity to the central server 110, 111, 121 (for instance together with the defined transaction in the above-discussed alternative embodiment).

In a subsequent transaction requesting step, the second client 21 may request, from the central server 110, 111, 121 and using said transaction identifier, the defined transaction. It is noted that this step may be unnecessary in case the second client 21 has already received the defined transaction from the first client 131 in the way described above.

In a subsequent transaction information provision step, the central server 110, 111, 121 may then provide, in response to said request, said transaction information to the second client 21.

The request and response, as well as said transaction sending step and any other step that requires communication between said clients 21, 22, 23, 131, 132, 133 and the central server 110, 111, 121, may take place over the internet 10, in a way which is conventional as such. It is preferred that an API exposed by the central server 110, 111, 121 and which is used by the first client 131 and the second client 21 to communicate with the central server 110, 111, 121, is a pull-type API, where any communication between the client 131, 21 in question is performed at the initiative not of the central server 110, 111, 121 but of the client 131, 21 in question. A possible exception is the below-described callback functionality. It is furthermore preferred that the present method is stateful in the sense that the central server 110, 111, 121 stores an updated current state of each handled transaction, and that the central server 110, 111, 121 updates this state by communicating in said manner with various clients 21, 22, 23, 131, 132, 133 that represent parties to each transaction in question, via said API.

In a subsequent payment information provision step, the second client 21 provides payment information, to the central server 110, 111, 121 and using said transaction identifier. In this context, “payment information” means any information using which a party can determine a payment method to use for transferring said value amount of the transaction in question. In particular, the payment information comprises a desired payment channel. As used herein, “payment channel” may be, for instance, information identifying a particular debit/credit card provider; information identifying a particular debit/credit card; an online payment service provider; information identifying a particular online payment service provider account or user; and so forth. It is understood that the payment channel may or may not in and of itself contain sufficient information to actually perform the payment in question. If the payment information in itself is not sufficient to perform the payment (for instance, if additional credit card data is required and/or if authentication factor information, such as a PIN or CVC code, a password or an SMS acknowledgement, is required), additional information and/or actions is or are provided or performed in a later payment execution step (see below).

In an available payment channel provision step, that may be performed before the payment information step, the first client 131 may provide, to the central server 110, 111, 121, a first set of available payment channels supported by the first client 131. This information may be provided by the first client 131 ahead of time, or in connection to the transaction at hand. For instance, a set of available payment channels may depend on a type of a current transaction and/or on an identity or type of the second client 21. Typically it is the first client 131 that determines the first set of payment channels, such as by a software function executing on or from the first client 131. Normally, the first set of payment channels does not comprise information about individual cards or user accounts, but is merely information identifying general identifying information about the payment channels in question.

In some embodiments, the above-discussed transaction information provision step comprises the central server 110, 111, 121 providing, to the second client 21, a second set of available payment channels, the second set being or being a subset of said first set of available payment channels. In particular, said desired payment channel may then selected, by the second client 21 or a user of the second client 21, from said second set.

The method may furthermore comprise a desired payment channel selection step, performed before the payment information provision step. In this desired payment channel selection step, the second client 21, or a user of the second client 21, may then select said desired payment channel from a third set of available payment channels. This third set of payment channels is then a subset of the above-mentioned second set of payment channels, the third set being determined by the second client 21 (or said user of the second client 21) as payment methods belonging to the second set of payment channels and also belonging to a fourth set of payment channels. The fourth set of payment channels, in turn, is a set of payment channels associated with the second client 21.

Hence, the fourth set of payment channels may be the set of payment channels that are supported by the second client 21. For instance, the fourth set may be all payment channels being supported by the second client 21 due to a pre-installation of software and/or information required to support payments using the payment channel in question. See below for practical examples. It may also be the case that the fourth set of payment channels is determined as those payment channels being supported by the second client 21 for the particular type of transaction at hand and/or for the particular user of the second client, as the case may be. The determination of the fourth set of payment channels may be determined by the second client 21, such as by a software function executed on or from the second client.

As described above, the first set of payment channels are those payment channels that are supported for the current transaction by the first client 131, and the second set of payment channels may be a set of payment channels both supported for the current transaction by the first client 131 and also by the central server 110, 111, 121. The third set of payment channels is then all payment channels both supported by the first client 131, the central server 110, 111, 121 and the second client 21 for the current transaction.

The selection of the desired payment channel, which is preferably only one single selected payment channel, which is preferably sufficiently precisely defined so that the central server 110, 111, 121 can initiate a payment procedure (see below) based on the selected payment channel without requesting additional information from the second client 21, may take place via an interactive user interface, such as a GUI or using buttons, provided on the second client 21 to a user of the second client 21.

In preferred embodiments, the present method may further comprise a fourth set determining step, wherein the second client 21 automatically determines what payment channels are available for use by the second client 21 (hence forming said fourth set of payment channels). In general, the fourth set determining step may comprise the second client 21 automatically determining whether or not a particular payment channel is preconfigured in the second client 21.

In particular, said fourth set determining step may comprise the second client 21 determining whether or not a particular local application is installed on the second client 21, the presence of such a local application indicating that a payment channel associated with the application in question is available for use by the second client 21. In this context, a local application means a software application locally installed on (an operating system of) the client device 21. This may be performed in different ways.

In a first alternative, the second client 21 comprises a web browser, using which a user of the second client 21 interacts with the system 100, such as via an interactive GUI presented by said browser on a screen of the second client 21. Then, the browser, when having loaded particular computer software code from a remote site, for instance being provided by a web server being a part of the central server 110, 111, 121 and/or the first client 131, is arranged to perform at least part of the fourth set determining step. In particular, in this first alternative such computer software code loaded from such a web server may be arranged to perform a check to see if one or several particular applications are locally installed on the second client 21 in question. A list of such particular applications to check may be provided to the second client 21 as a part of such loaded computer software code, together with information required to perform such a check (for instance the name or identifier of such an application).

For instance, code of the following type (in this example in IOS) may be performed in said browser to check if a Swish® application is available or not as an installed application on the second client 21:

setTimeout(function ( ) { window.location=
″https://<base_URL>/swish_not_available_application″; }, 25);
window.location = “swish://″;

Using this code, if launching Swish® application is successful at the third line, line 1 and 2 will have no effect. However, if Swish® is not installed on the device, the execution of the third line will fail and instead the “swish_not_available_application” is executed through which i.e. a cookie can be set in the browser to mark that Swish® is not available on this device or execute any other desired operation.

In a second alternative, the second client 21 comprises a locally installed application (an “app” as defined above) using which said user of the second client 21 interacts with the system 100, such as via an interactive GUI presented by said app on the screen of the second client 21, in a way which otherwise is analogous to the case with said browser. The app may communicate with the central server 110, 111, 121 and/or the first client 131 via suitable APIs. Then, said app may perform at least part of the fourth set determining step, and in particular to perform a check to see if one or several particular applications are locally installed on the second client 21. A list of such particular applications may, again, be provided to the second client 21 from the central server 110, 111, 121 and/or the first client 131.

The following is an example of code that can be (compiled and) executed on the IOS system to perform a check if said Swish® application is available or not as an installed application on the second client 21:

let appName = “swish″
let appScheme = ″\(appName)://app″
let appUrl = URL(string: appScheme)
if UIApplication.shared.canOpenURL(appUrl! as URL) {
// The Swish application is installed - do something
}

In case a locally installed application is detected on the second client 21, the second client 21 may assume that the payment channel associated with the detected application is available for use on and from the second client 21 in question for the transaction in question.

As an alternative to detecting whether or not a locally installed payment application is installed on the second client 21, the fourth step may comprise checking whether or not a payment channel is preconfigured on the second client 21 in one or several of the following ways:

In a first example, the browser or app may be associated with a remote login session in relation to the central server 110, 111, 121 and/or first client 131, the login session making user information available to the second client 21 about available preconfigured payment channels usable from the second client 21. For instance, stored credit card or web payment service account information may be made available this way to the second client 21.

In a second example, an app of the above-discussed type (for use within the system 100) may have been used by a user of the second client 21, during an installation and/or configuration process of such an app, to provide information about preconfigured payment channels of said user and that are to available using the second client 21.

In a third example, information sufficient to perform at least part of a payment from the second client 21 may be available on the second client 21 itself, for instance registered in a different application or operating system registry of the second client 21, in a way making it possible for said app or browser to detect such information by investigating information stored in a file folder or operating system registry in the second client 21. For instance, a tokenised credit card may be stored this way on the second client 21.

Preferably, the app or browser on the second client 21 automatically performs at least one or some of these checks, in addition to any additional checks of similar type, in order to establish said fourth set of payment channels.

Further preferably, when performing said checks the app or browser also automatically collects from the appropriate source in the second client 21 any (or at least some of the) information that may be necessary to perform the payment in question in relation to the current transaction in question. At least part of this collected information then forms part of said payment information (regarding the desired payment channel) provided to the central server 110, 111, 121 from the second client 21.

In a subsequent payment execution step, the payment in question is then executed based on the above-discussed payment information, using said desired payment channel.

In general, the payment execution step is performed by the second client 21 and/or the central server 110, 111, 121, preferably not involving the first client 131 in any way. In case a POS 121 is used at, for instance, a merchant, it is preferred that this POS server 121 is also not used in the payment execution step, but that the central server 111 being central in relation to the entire system 100 (also serving other POS servers 122) is used to execute the payment.

The payment may be executed in several different ways, according to the following.

In a first example, the central server 110, 111, 121 in question receives the desired payment channel from the second client 21 and, as a result, contacts the corresponding payment provider with a payment request associated with the second client 21. The payment provider then communicates with the second client 21, such as with a payment application installed and executing on the second client 21, to finalise the payment based on information provided in said payment request. This payment application may be an application automatically detected on the second client 21 described above.

In the concrete example of a Swish® payment, the following steps may then be performed:

First, a token received from a Swish® backend server is returned to the second client 21, in step 313. Then the browser or the app automatically launches the Swish® payment application with the received token from Swish®. After this point, the Swish® payment application will take over and guide the user through the Swish® payment flow. Once the payment is finalized, the Swish® backend will send a callback to the central server (110,111,121; 122) which in turn send this information to second client 21 (step 315 in the example illustrated in FIG. 3) and to the first client (step 318 in FIG. 3).

In a second example, the second client 21, provides to the central server 110, 111, 121 a token uniquely identifying a debit/credit card at a specific card payment provider, such as VISA® or MasterCard®. The central server 110, 111, 121 then sends the card token information together with the charge amount to the card payment provider. The payment flow may then involve the second client 21, for instance by the card payment provider encouraging the user of the second client 21 to enter a PIN or CVC code using the second client 21 GUI. Once the payment is finalized, the card payment provider either sends a callback to the central server 110, 111, 121 or the central server 110, 111, 121 fetches the information from it. The payment result is then, correspondingly as above, sent to second client 21 and to the first client.

In a third example, a direct account payment service provider is used, such as a direct bank transfer or a direct payment service such as Klarna® or PayPal®. Such a direct payment service may have an account of the user of the second client 21, or may have a pre-defined post-payment arrangement with this user. This is then performed in a corresponding manner as described above, for instance by the central server 110, 111, 121 initiating with such an identified direct account payment service provider a monetary transfer as defined by the defined transaction from the user of the second client 21. The second client 21 may be used to enter a PIN code or in any other way be used as an authentication factor of said user.

It is noted that in all of these examples the central server 110, 111, 121 initiates the payment based on the provided desired payment channel, this initiation taking place directly between the central server 110, 111, 121 and the payment service provider 31, 32, 33 in question. Normally, the second client 21 will be used to allow the user thereof to authenticate the payment as a part of some or any payment flow supported by the central server 110, 111, 121, for instance by using the second client 21 as an authentication factor (such as a something-you-have or something-you-know factor). Such authentication will normally take place directly between the payment service provider 31, 32, 33 and the second client 21, not involving the central server 110, 111, 121.

Moreover as a part of this payment execution step, the central server 110, 111, 121 is hence provided with payment confirmation information regarding said payment. This payment confirmation information may be provided to the central server 110, 111, 121 from the second client 21 or be provided directly from the payment service provider 31, 32, 33 in question to the central server 110, 111, 121, depending on the detailed payment flow in relation to that payment service provider 31, 32, 33 in question. The central server 110, 111, 121 will typically use an available callback or return value functionality of the payment service provider 31, 32, 33 used to gain information about payment success and finalisation.

It is understood that any selected desired payment channel may involve a particular associated respective payment service provider 31, 32, 33.

In a subsequent payment confirmation step, the central server 110, 111, 121 provides, to the first client 131 and using said transaction identifier, payment confirmation. This may, for instance, imply that the first client 131 can release a purchased product to a user of the second client 21. This confirmation may be provided to the first client 131 via a callback mechanism, as exemplified below, or by polling the status of the payment with the central server 110, 111, 121 using a suitable polling API.

Using such a method, a transaction between a user of the first client 131 and a user of a second client 21 can be performed in a way which is very flexible in terms of what payment service provider 31, 32, 33 to use, without a user of the first client 131 having to be at all actively involved in the selection or determination of what payment channel to be used. It is even possible that the first client 131 outsources everything having to do with payment channels to the central server 110, 111, 121, in the sense that the first set of payment channels is not provided or covers any payment channel. In other words, the central server 110, 111, 121, in its provision of the second set of payment channels, determines what payment channels are available to perform the payment in question. Then, after selection of the desired payment channel, the payment execution takes place involving only the second client 21 and/or the central server 110, 111, 121 (and of course the payment service provider 31, 32, 33 in question), but not requiring participation by the first client 131 (and possibly also no participation by the POS server 121 of the first client 131).

This way, the merchant does not have to spend any resources on setting up agreements, infrastructure and updated payment plugin software for any payment channels at all, but can still receive payments using the central server 110, 111, 121.

In other examples, a POS server 111 is used to support various payment channels in a merchant-central manner, whereby the individual POS clients 131, 132, 133 do not need to implement any payment channel-specific functionality.

Since both the first client 131 and the second client 21 only communicate (with respect to the payment) with the central server 110, 111, 121, and since all relevant information about the transaction is stored in the central server 110, 111, 121, various actions performed by a respective user of the first client 131 and/or the second client 21 can be performed in a fully unsynchronous manner, minimising any need for communication or negotiation between the first client 131 and the second client 21. For instance, a user of the second client 21 can change client devices in the middle of a purchase and continue the purchase process from the other client device just by activating a login or similar on the other client device. In another example, the user of the second client 21 can initiate a purchase at one POS and then finalise the purchase at a different POS by, for instance, performing the above-discussed identifier provision step in relation to the other POS client device.

In one particular example, the method may furthermore comprise a transaction reversing (return) step, wherein the transaction is reversed by a third client 21, 22, 23, that may be the same as the above-discussed second client 21.

Such a transaction reversing step may then further comprise the third client 21, 22, 23 providing the transaction identifier to the central server 110, 111, 121. The first client 131, 132, 133 may then provide reverse payment confirmation to the central server 110, 111, 121, for instance in reaction to information about the requested payment reversal provided to the first client 131, 132, 133 from the central server 110, 111, 121.

Such reverse payment confirmation may be a simple acknowledgement that the payment should be reversed, or may include more specific information such as a partial payback or a desired reverse payment channel to use. The desired reverse payment channel may be a payment channel selected from a set of payment channels that are supported by both the third client 21, 22, 23 and the central server 110, 111, 121, said set being established using a methodology corresponding to the one described above (in relation to the determination of the desired payment channel of the second client 21), by the third client 21, 22, 23 providing a set of determined supported payment channels to the central server 110, 111, 121, and the central server 110, 111, 121 providing the subset of these payment channels that are also supported by the central server 110, 111, 121 to the first client 131, 132, 133, and whereby the first client 131, 132, 133 (or a user thereof) may select a desired one of these available payment channels to use for the reverse payment.

The central server 110, 111, 121 may then execute the reverse payment using the same desired payment channel as used for the payment as described above, using the corresponding payment service provider 31, 32, 33 and using the stipulated payment amount. The execution of the reverse payment may be a payment execution of the general type described above, but sending the payment amount in the opposite direction, using the same payment channel or a different one, as may be specified by the first client 131, 132, 133. Hence, the third client 21, 22, 23 may be involved in the general manner described above in the execution of this return payment.

Then, the central server 110, 111, 121 may provide, to the POS in question (such as the first client 131) and/or to the second client 21, a confirmation of the reversing of the transaction. For instance, this means that the POS can accept the return of a previously purchased product.

In a subsequent step, the method ends.

As is understood from the above, the transaction identifier is used by all parties in the system 100 to unambiguously refer to the transaction, information about which is held in a stateful manner by the central server 110, 111, 121. This makes it possible for any party to act on a particular transaction in various ways by sending a corresponding request to the central server 110, 111, 121, referring to the transaction identifier in question.

In case no supported payment channels can be detected on the second client 21, the central server 110, 111, 121 may provide a default payment channel, that can be selected by a user of the second client 21 using said browser or app, the default payment channel being configured by the central server 110, 111, 121 to be available for all transactions and clients/users.

In preferred embodiments, the determination of the first, second, third and fourth payment channels is performed at every transaction. This provides an updated view of available payment channels (that may change over time and across different transaction types, users, and so forth). On the other hand, said browser or app in the second client 21 may be arranged to store a favourite or last desired payment channel selection, so that a user of the second client 21 for example does not have to manually select the same desired payment channel for every transaction, as long as that desired payment channel is in fact available for making the payment.

The central server 110, 111 and/or 121 exposes various APIs, and provides functionality via these APIS. In the following, a number of examples of this will be described, in order to illustrate the principles described above.

### Example 1: Create Payment Object API

This API allows a client to send transaction information to the central server so as to incite the central server to define a transaction as a new payment object.

The client can create a Payment Object using the following URL:
POST <base_URL>/payment-service/v1/api/payment_services/payment

In the body, the following JSON also referred to as “Payment Data” may be provided:

```
{
  “commonProductDetails”: {
    “storeId”: “3115”,
    ## The ID for the company/merchant in question
    “message”: “your Message to the consumer”
    “paymentRef”: “000515a3-91d6-4ed8-a528-59715e6f2618”,
    ## A unique UUID
    “currency”: “SEK”,
    ## The desired currency type
    “paymentType”: “undefined”,
    ## This should be det as “undefined” in order to let the
    consumer choose the desired payment type.
    “amount”: “5000”,
    ## This is the total invoice amount
    “callBackURL”: “https://<your-domain>/<what-ever-path>”,
    ## The callback URL which will be called every time the
    payment status changes.
    “authorization_key”: “1212121212112”,
    ## A key provided by you in order to identify the callback.
    This could be any value and can be also reused for multiple
    calls.
    “vat_amount”: “0”,
    ## VAT amount
    “order_items”: “[{ \“name\” : \“Payment for job\” ,
    \“price_per_unit\”
    : \“1000\” , \“quantity\” : \“5\” , \“vat_per_unit\” :
    \“0.25\” }]”,
    ## If desired, you can provide the list of items and their
    specifications to be shown to the consumer. This could be
    sent as empty object too and thereby o items will be shown
    to the consumer.
    “customer_order_ref”: “1234243234”,
    ## This is for your reference to identify the payment in
    your system. This for example can be an OCR or invoice
    number.
    “payer_number”: “4676111111”
    ## This is an option field that could be filled if the
    payer's number is known to the payee beforehand. Otherwise
    send an empty string.
  }
}
```

The return value may be as follows:

```
{
  “type”: “undefined”,
  “token”: “undefined”,
  “url”: “https://<base_URL>/payment-service/000515a3-91d6-4ed8-
  a528-39715f6f2618”
}
```

The customer can then use the “url” returned by the central server to let the client pay the Payment Object. This can be done for example by creating a QR-code of this data or a clickable object in a web page.

### Example of Usage

```
curl --location --request POST ‘https://<BASE-
URL>/v3/payment/000515a391d64ed8a52859715e6f2618/pay’ \
--header ‘Content-Type: application/json’ \
--header ‘Accept: application/json’ \
--header ‘ApiKey: <your-ApiKey>’
--data-raw ‘{
  “paymentType”: “SWISH”,
  “paymentMetadata”: {
    “phoneNumber”: “+4674886343432”,
    “consumerId”: “9829412693726”
  },
}’
```

Once the Payment Object changes status the provided callback will be called by the central server, and the recipient will get the updated Payment Data (see above) in the body of the API call.

### Example 2: Get Information about a Payment Object

A client may be able to retrieve the latest status and information about a previously created Payment Object by calling the following API:
Get<base_URL>/payment-service/v1/api/payment_services/payment/<orderRef>

### Example of Usage

curl --location --request GET ‘https://<base_URL>/pay-
mentservice/v1/api/payment_services/payment/f95e572a-3f7f-41f1-
b937-d99f04a15ea3’ \
--header ‘Content-Type: application/json’ \
--header ‘Accept: application/json’

### Example 3: Cancel a Payment Object

This API allows a client to cancel a previously defined Payment Object. If the client has not managed to pay for the object, it will be cancelled, and the consumer will not be able to pay for that object anymore. If the object is already paid for, it will not be possible to cancel it anymore and the call will return an error.

A Payment Object can be cancelled by calling the following API:
Put <base_URL>/payment-service/v1/api/payment_services/cancel/<orderRef>

### Example of Usage

curl --location --request GET ‘https://<base_URL>/
paymentservice/v1/api/payment_services/cancel/f95e572a-3f7f-41f1-
b937-d99f04a15ea3’ \
--header ‘Content-Type: application/json’ \
--header ‘Accept: application/json’

### Example 4: Refund

A client may be able to partially or fully refund a previous payment by using the following API:
Patch<base_URL>/payment-service/v1/api/payment_services/refund/<orderRef>

### Example of Usage

```
curl --location --request POST ‘https://<base_URL>/
paymentservice/v1/api/payment_services/payment/refund/f95e572a-
3f7f-41f1-b937-d99f04a15ea3’ \
--header ‘Content-Type: application/json’ \
--header ‘Accept: application/json’
--data-raw ‘{
  “refundAmount”: “120”,
  “message”: “YOUR MESSAGE TO THE CUSTOMER GOES HERE”,
  “callBackURL”: “https://<YOUR.DOAIN>/Callback”,
  “authorization_key”: “12312312323534345”,
  “orderItems”: “”
}’
```

FIG. 3 illustrates an example of a flow for processing a transaction, in particular a purchase transaction, involving a payment from the second client 21 to the first client 131.

In a step 301, an order is created at the first client 131, in one of the ways described above.

In a step 302, order data is sent to the POS server 121 associated with the first client 131.

In a step 303, the order is sent to the central server 111, such as by using the following API call:
POST Payment (payment_ref, store_id, amount, currency, message, merchant_ref, item, list, callbackURL, authorization_key)

In a step 304, the central server 111 defines the transaction and returns information sufficient to determine the transaction identifier to the POS server 121. For instance, such information may be information based on which a QR code can be constructed as a visual code.

In a step 305, the information is sent to the first client 131.

In a step 306, the first client 131 displays said QR code on its screen.

In a step 307, the second client 21 scans and interprets the displayed QR code using its built-in digital camera and standard image processing software.

In a step 308, the second client 21 requests transaction information from the central server 111, for instance using the following API call:
GET Payment (QR-code data)

In a step 309, the central server 111 returns the transaction information, including accepted payment channels by the merchant, to the second client 21, for instance in the form of the following information:
store_id, amount, currency, message, payment_ref, item_list, accepted_payment_channels_list

In a step 310, payment information is displayed to a user of the second client 21, on a built-in screen of the second client 21. This payment information may comprise various available payment channels, such as the payment channels available for both the first client 131, the central server 111 and the second client 21, that may have been determined by the app or browser on the second client 21 as described above. It is understood that a list of payment channels accepted by the central server 111 may optionally be fetched by the second client 21 through a separate API call.

In a step 311, the user of the second client 21 selects the desired payment channel, acknowledging that payment is to be performed.

In a step 312, the second client 21 sends desired payment channel information to the central server 111, for instance using the following API call (“PaymentTyp” signifying the desired payment channel):
PUT Payment (PaymentType)

In a step 313, the central server 111 initiates a payment flow with the payment service provider 31 corresponding to the selected desired payment channel. This initiation may be as exemplified above.

In a step 314, the payment service provider 31 sends payment flow information to the second client 21, such as the triggering of an authentication by a user of the second client 21 as exemplified above.

In a step 315, the second client 21 manages the authentication of the payment flow in question, also as exemplified above. This may involve the user of the second client 21 entering, via a GUI provided on the second client 21, a PIN code for the payment.

In a step 316, user authentication information is sent back from the second client 21 to the payment service provider 31.

In a step 317, the payment is effectuated by the payment service provider 31. This may involve, for instance, the recordation of movement of a corresponding money amount from a first account to a second account.

In a step 318, successful payment confirmation is sent from the payment service provider 31 to the second client 21, by pushing or polling.

In a step 319, the second client 21 displays the payment result to the user of the second client 21.

In a step 320, the payment service provider 31 acknowledges successful payment effectuation to the central server 111.

In a step 321, the central server 111 calls the callback function, according to the previously provided callbackURL, together with the payment result received from the second client 21. This callback is in this example received by the POS server 121.

In a step 322, the POS server 121 notifies the first client 131 about the payment result.

As is clear from FIG. 3, the POS server needs only place one single API call and receive one single callback to be able to handle the payment using any payment channel supported by the central server 111 and the second client 21.

FIG. 4 illustrates an alternative embodiment, in which the first client 131 provides the defined transaction to the second client 21, which then relays the defined transaction to the central server 111, as described above.

In a step 401, an order is created at the first client 131, in a way corresponding to step 301 as described in connection to FIG. 3.

In a step 402, the first client 131 displays information about the order, sufficient to define the corresponding transaction, such as in the form of a properly coded QR code, on its screen.

This information about the order also comprises callback information. It may also comprise the transaction identifier, in that case defined by the first client 131. However, in the present example the transaction identifier is defined by the central server 111 just like in the example illustrated in FIG. 3.

The information about the order may also comprise information regarding what payment channels that the first client 131 supports.

In a step 403, the second client 21 scans and interprets the displayed information using its built-in digital camera and standard image processing software.

In a step 404, the order is sent by the second client 21 to the central server 111, such as by using the above-mentioned API call or another API call. Since information about supported payment channels and similar might be sensitive, the information about the order may be encrypted so that the second client 21 cannot interpret the information apart from conveying it as it is to the central server 111.

In a step 405, the central server 111 defines the transaction and returns information sufficient to determine the transaction identifier to the second client 21.

In the same step 405, information regarding payment channels supported by the central esrver 111 (and possibly payment channels supported by both the central server 111 and the first client 131) may also be sent to the second client21.

Thereafter, steps 406-418 correspond to steps 410-422 of FIG. 3. Notably, the notification to the first client 131 in step 418, that the payment has been completed, is made using the callback information provided to the second client 21 in step 403 and to the central server 111 in step 404.

The invention also relates to the system 100 as such, the system 100 then being arranged to perform a transaction of the above-described type, between the second client 21, 22, 23 and the first client 131, 132, 133. In this case, the central server 110, 111, 112, 122 is specifically arranged to receive the defined transaction from the first client 131, 132, 133 in said transaction sending step; to perform the association step; to receive the request for the defined transaction from the second client 21, 22, 23 in the transaction requesting step; provide at least part of the transaction information to the second client 21, 22, 23 in the transaction information provision step; to receive the payment information from the second client 21, 22, 23 in the payment information provision step; perform the payment execution step; and provide the payment confirmation in the payment confirmation step.

Furthermore, the invention relates to the computer software product as such, the computer software product also being arranged to perform a transaction of the above-described type, between the second client 21, 22, 23 and the first client 131, 132, 133. In this case, the computer software product, when executed on or from the central server 110, 111, 121, 122, the first client 131, 132, 133 and/or the second client 21, 22, 23, is arranged to perform the above-described steps. In each step, respective parts of the computer software product may be executed on or from the respective involved parties so as to perform the steps in question. The computer software product may hence be stored on respective non-transitory, computer-readable memory in the respective unit in question, or stored elsewhere but in a manner accessible to the unit in respective question, and executed so as to perform the respective method step in question.

Above, preferred embodiments have been described. However, it is apparent to the skilled person that many modifications can be made to the disclosed embodiments without departing from the basic idea of the invention.

For instance, the central server 110 may expose many other functions in relation to transactions stored therein via corresponding APIs.

Anything which has been said herein about the present system is equally applicable to the present method and computer software product, and vice versa.

Hence, the invention is not limited to the described embodiments, but can be varied within the scope of the enclosed claims.

1. A method for performing a transaction between a second client and a first client, the method comprising
a transaction definition step, wherein a transaction is defined by the first client and/or the second client, the defined transaction comprising transaction information in turn comprising a payment amount to be received by the first client, the transaction being defined in a way so that the first client can determine the payment amount and to what the payment amount relates;
a transaction sending step, wherein the first client sends, digitally and electronically, the defined transaction to a central server;
an association step, wherein the defined transaction is associated, in the central server, with an identifier;
an available payment channel provision step, wherein the first client provides, digitally and electronically, to the central server, a first set of available payment channels supported by the first client;
an identifier provision step, wherein the identifier is communicated to the second client;
a transaction requesting step, wherein the second client requests, digitally and electronically, from the central server and using said identifier, the defined transaction;
a transaction information provision step, wherein the central server provides, digitally and electronically, to the second client, said transaction information and a second set of available payment channels, the second set being or being a subset of the first set of payment channels supported by the central server;
a payment information provision step, wherein the second client provides, digitally and electronically, to the central server and using said identifier, payment information, the payment information comprising a desired payment channel selected from said second set;
a payment execution step, wherein the payment of said payment amount is executed by the central server and/or the second client based on said payment information, using said desired payment channel and wherein the central server is provided, digitally and electronically, payment confirmation information regarding said payment; and
a payment confirmation step, wherein the central server provides, digitally and electronically, to the first client and using said identifier, payment confirmation.

2. The method of claim 1, wherein, in the identifier provision step, the identifier is communicated to the second client by the first client reading the identifier by performing at least one of:
visually depicting, using a digital camera of the second client, a displayed visual code signifying the identifier;
recording, using a microphone of the second client, an emitted audio code signifying the identifier;
receiving, using an antenna of the second client, a wireless signal signifying the identifier; and
allowing a user of the second client to select a graphical object, link or URL in a GUI presented on a screen of the second client.

3. The method of claim 2, wherein the identifier is locally communicated to the second client by the first client.

4. The method of claim 1, wherein the first client is not involved in the payment execution step.

5. The method of claim 1, further comprising:
a desired payment channel selection step, wherein the second client, or a user of the second client, selects the desired payment channel from a third set of available payment channels, the third set being a subset of the second set determined by the second client as payment methods belonging to the second set and also belonging to a fourth set of payment channels, the fourth set being a set of payment channels associated with the second client.

6. The method of claim 5, further comprising:
a fourth set determining step, wherein the second client automatically determines what payment channels are supported by the second client.

7. The method of claim 6, wherein the fourth set determining step comprises the second client determining whether or not a particular local application is installed on the second client.

8. The method of claim 7, wherein the second client comprises a web browser performing at least part of the fourth set determining step.

9. The method of claim 6, wherein the fourth set determining step comprises the second client determining whether or not a particular payment channel is preconfigured in the second client.

10. The method of claim 9, wherein the second client comprises a locally installed application performing at least part of the fourth set determining step.

11. The method of claim 1, further comprising:
a transaction reversing step, wherein the transaction is reversed by a third client, that may be the same as the second client, the transaction reversing step further comprising
the third client providing the identifier to the central server;
the first client sending reverse payment confirmation information to the central server;
the central server executing the reverse payment; and
the central server providing, to the second client, a confirmation of the reversing of the transaction.

12. A system for performing a transaction between a second client and a first client, the system comprising a central server arranged to perform:
a transaction sending step, wherein a defined transaction is received, digitally and electronically, from the first client;
an association step, wherein the defined transaction is associated with an identifier;
an available payment channel provision step, wherein a first set of available payment channels supported by the first client is received, digitally and electronically, from the first client;
a transaction requesting step, wherein the defined transaction is requested, digitally and electronically, by the second client and using said identifier;
a transaction information provision step, wherein said transaction information and a second set of available payment channels is provided, digitally and electronically, to the second client, the second set being or being a subset of the first set of payment channels supported by the central server;
a payment information provision step, wherein payment information is received, digitally and electronically, from the second client using said identifier, the payment information comprising a desired payment channel selected from said second set;
a payment execution step, wherein the payment of said payment amount is executed based on said payment information, using said desired payment channel, and wherein payment confirmation information is received regarding said payment; and
a payment confirmation step, wherein payment confirmation is provided, digitally and electronically, to the first client using said identifier.

13. A computer software product for performing a transaction between a second client and a first client, the computer software product, when executed on or from a central server, the first client and/or the second client, being arranged to perform:
a transaction definition step, wherein a transaction is defined by the first client and/or the second client, the defined transaction comprising transaction information in turn comprising a payment amount to be received by the first client, the transaction being defined in a way so that the first client can determine the payment amount and to what the payment amount relates;
a transaction sending step, wherein the first client sends, digitally and electronically, the defined transaction to a central server;
an association step, wherein the defined transaction is associated, in the central server, with an identifier;
an available payment channel provision step, wherein the first client provides, digitally and electronically, to the central server, a first set of available payment channels supported by the first client;
an identifier provision step, wherein the identifier is communicated to the second client;
a transaction requesting step, wherein the second client requests, digitally and electronically, from the central server and using said identifier, the defined transaction;
a transaction information provision step, wherein the central server provides, digitally and electronically, to the second client, said transaction information and a second set of available payment channels, the second set being or being a subset of the first set of payment channels supported by the central server;
a payment information provision step, wherein the second client provides, digitally and electronically, to the central server and using said identifier, payment information, the payment information comprising a desired payment channel selected from said second set;
a payment execution step, wherein the payment of said payment amount is executed by the central server and/or the second client based on said payment information, using said desired payment channel and wherein the central server is provided payment confirmation information regarding said payment; and
a payment confirmation step, wherein the central server provides, digitally and electronically, to the first client and using said identifier, payment confirmation.
